(19) United States
(12) Patent Application Publication
(10) Pub. No.: US 2026/0059078 A1
(43) Pub. Date: Feb. 26, 2026

(54) MIXED-MEDIA, MULTI-SCREEN, AND PANORAMIC PROJECTION SYSTEM

(71) Applicant: Base Xperiential, LLC, Houston, TX (US)

(72) Inventors: Ryan Latham, Houston, TX (US); Steve Sterling, Houston, TX (US); John Procaccini, Houston, TX (US); Brian Becker, Houston, TX (US); Allen Rudolph, Houston, TX (US)

(73) Assignee: Base Xperiential, LLC, Houston, TX (US)

(21) Appl. No.: 18/383,898

(22) Filed: Oct. 25, 2023

Related U.S. Application Data
(60) Provisional application No. 63/419,332, filed on Oct. 25, 2022.

(51) Int. Cl. G02B 30/52; G03B 21/56

(52) U.S. Cl. CPC H04N 9/3147; G02B 30/52; G03B 21/26; G03B 21/56

(57) ABSTRACT

The present invention provides a multi-media, multi-screen, and panoramic projection system (“Holotheater”) that presents three-dimensional, lifelike holographic imagery. The elements of the Holotheater are capable of being integrated into existing venues. The Holotheater comprises a scrim, a rear screen positioned behind the scrim, and an assortment of projectors. Each projector projects a portion of an immersive experience which, when displayed on the scrim and rear screen, appears three-dimensional to an audience without requiring headsets. In some embodiments, additional side screens may be used with corresponding projectors to create a vivid panoramic presentation.

### CROSS-REFERENCE TO RELATED APPLICATION

The present application claims priority to U.S. Provisional Ser. No. 63/419,332 , entitled “Mixed-Media, Multi-Screen, and Panoramic Projection System,” and filed on Oct. 25, 2022, the entire disclosure of which is incorporated by reference herein.

### BACKGROUND OF THE INVENTION

### 1. Field of Invention

The present invention relates to immersive video displays and digital theatre technology for audiences.

### 2. Description of Related Art

Immersive video display environments utilize real-time or pre-rendered digital content. Immersive environments have evolved from numerous influences, including immersive art and storytelling, with technological roots in planetariums, multi-projector film environments, flight simulation, and virtual reality.

Digital theatre is a hybrid art form, gaining strength from a theatre's ability to facilitate the imagination and create human connections and digital technology's ability to extend the reach of communication and visualization. Digital theatre combines pre-recorded digital media with live performers in the same unbroken space with a co-present audience. For example, recent holographic touring productions of Roy Orbison, Maria Callas, Buddy Holly, and Whitney Houston bring together a video performance of the artist and studio recordings with live bands, backup singers, or dancers to create an authentic concert experience. Many remember the holographic representations of Michael Jackson at the Billboard Music Awards in 2014 and Tupac Shakur at the Coachella Valley Music & Arts Festival in 2012 as particularly groundbreaking.

The idea of holograms has been around since the 1800s and was invented by John Pepper, using a technique known as Pepper's Ghost, which relied on the reflection of an image onto a piece of glass, angled to capture light and reflect the image onto the stage, providing the audience with the illusion of a ghostly presence. Technically, the image is not a hologram, defined as a light-beam-produced, three-dimensional image visible to the naked eye. However, by projecting the hologram onto a transparent display screen such as clear Mylar film or see-through scrim, a holographic image appears three-dimensional to audiences.

Alternatively, the display of three-dimensional imagery has relied on the use of headsets. A virtual reality headset or VR headset is a head-mounted device that provides virtual reality for the wearer. VR headsets are widely used with video games, but they are also used in other applications, including simulators and trainers. VR headsets typically include a stereoscopic display providing separate images for each eye, stereo sound, and sensors like accelerometers and gyroscopes for tracking the pose of the user's head to match the virtual camera's orientation with the user's eye positions in the real world. VR headsets offer an immersive experience, but many people report headaches, eye strain, dizziness, and nausea triggered by the virtual reality illusion, which makes the eyes focus on objects appearing in the distance that are actually on a screen just centimeters away.

A need exists to improve an audience-viewing experience that delivers three-dimensional imagery without headsets.

### SUMMARY OF THE INVENTION

The present invention overcomes these and other deficiencies of the prior art by providing a multi-media, multi-screen, and panoramic projection system (referred to in the industry as a “Holotheater”), with its centerpiece attraction being three-dimensional, lifelike holographic imagery. In a preferred embodiment of the invention, the projection system comprises a scrim suspended between an audience area, i.e., house, and a rear projection screen. The scrim and rear projection screen are oriented vertically between a floor and a ceiling (or a supporting truss near the ceiling or floating above the stage). The floor may be a stage of a theatre. The invention utilizes two projectors for projecting an image onto the scrim: one projector on the floor projecting towards the top of the scrim and the other projector on the ceiling projecting towards the bottom of the scrim.

Each of these projectors only uses a portion, e.g., half, of the projection image. For example, the floor projector projects the top part of the image, while the ceiling projector projects the bottom part. The respective unused portions are cropped out to not project onto the scrim, thus permitting the projectors to be hidden from an audience while still projecting the entire image onto the scrim for the audience to see. Like in traditional movie theatres, the rear projection screen may be flat or slightly curved. In an optional embodiment of the invention, the projection system further comprises two or more additional projection surfaces and a range of projectors and other equipment, including short-throw lenses, a media server, and ultra-high-definition devices such as but not limited to HDBaseT cable and compatible devices to illuminate supplemental imagery around the scrim and rear projection screen to create a panoramic experience for the audience.

In an embodiment of the invention, a projection system comprises a scrim suspended vertically between a floor and a ceiling; a projection screen, wherein the scrim is located between the projection screen and an audience area configured to view the projection system; a first projector projecting, at an upward angle, a first portion of a first image; a second projector projecting, at a downward angle, a second portion of the first image, wherein the first image comprises the first portion and the second portion; and a third projector projecting a first portion of a second image onto the projection screen. The scrim and rear projection screen are arranged to form an illusion of a three-dimensional image, as seen in the audience area, comprising the first image and the second image. The first projector and second projector are configured as front projectors, and the third projector is configured as a rear projector. The scrim comprises a reflective projection scrim or a silvered, fire-retardant gauze. The first portion is a top portion cropped from the first image, the second portion is a bottom portion cropped from the first image, and the top and bottom portions do not overlap. The cropped portions of the first image are not projected. A fourth projector may project a second portion of the second image onto the projection screen, and a fifth projector may project a third portion of the second image onto the projection screen. The system may further comprise one or more side wall screens, wherein each side wall screen is arranged adjacent to either the left or right side of the rear projection screen or the scrim or both the rear projection screen and the scrim. The system may further comprise a side wall projector for each side wall screen to project an image complementary to the first image or the second image.

In another embodiment of the invention, a method of presenting three-dimensional mixed media projections comprises the steps of dividing a first image into a first portion and a second portion, projecting the first portion on a top portion of a scrim, projecting the second portion on a bottom portion of a scrim, and projecting a second image on a screen, wherein the screen is located upstage of the scrim. The method may further comprise the step of suspending the scrim vertically between a ceiling and a stage. The method may further comprise the steps of arranging a first projector aimed toward the top portion of the scrim, the first projector projecting the first portion on the top of the scrim, arranging a second projector aimed toward the bottom portion of the scrim, the second projector projecting the second portion on the bottom of the scrim, and arranging one or more additional projectors aimed toward the rear of the screen, the one or more additional projectors projecting the second image on the screen. The method may further comprise the step of aligning the first portion on the top portion of the scrim and the second portion on the bottom portion to create a seamless first image and an illusion of a three-dimensional image comprising the first and second images. The method may further comprise projecting one or more other images on one or more side wall screens adjacent to either the left or right side of the screen or the scrim or both the screen and the scrim. The method may further comprise installing the scrim and one or more side wall screens into a preexisting theatre comprising the screen.

The present projection system is flexible and deployable, integrated into various existing spaces to convert them into multi-use venues. For example, theatres can present both holographic presentations and traditional big-screen content. The invention allows hologram integration into a broader range of venues and uses. An advantage of the present invention is that the audience experience does not require wearable hardware such as goggles, headsets, or 3D glasses. The audience takes a seat and lets the technology transform the theater around them into an immersive environment and shared experience.

The foregoing and other features and advantages of the invention will be apparent from the following, more particular descriptions of the preferred embodiments of the invention, the accompanying drawings, and the claims.

### BRIEF DESCRIPTION OF THE DRAWINGS

For a more complete understanding of the present invention and advantages thereof, reference is now made to the ensuing descriptions taken in connection with the accompanying drawings briefly described as follows:

FIG. 1 illustrates a multi-media, multi-screen projection system according to a core embodiment of the invention;

FIG. 2A illustrates a side view of a multi-media, multi-screen projection system in a theatre according to an embodiment of the invention;

FIG. 2B illustrates a top view of the multi-media, multi-screen projection system shown in FIG. 2A;

FIG. 2C illustrates a side view of the multi-media, multi-screen projection system shown in FIG. 2A with the addition of side wall projection screens;

FIG. 3 illustrates a top view of the multi-media, multi-screen, panoramic projection system shown in FIG. 2A;

FIG. 4 illustrates a front view of a multi-media, multi-screen projection system in a theater, including the addition of muslin side wall screens, according to an embodiment of the invention;

FIG. 5 illustrates the addition of panels of muslin side wall screens on the upper and lower portions of a right wall of a theater according to an embodiment of the invention;

FIG. 6 illustrates the addition of panels of muslin side wall screens on the upper and lower portions of a left wall of a theater according to an embodiment of the invention;

FIG. 7 illustrates a bottom-up view of the roof of a theater according to one embodiment of the invention, including the locations of a hanging projector and scrim truss;

FIG. 8 illustrates an elevated back view of a theater, including the locations of a new truss, a scrim truss, a hanging projector, and ground-supported projectors according to one embodiment of the invention;

FIG. 9 illustrates a front view of the screen and scrim arrangement according to one embodiment of the invention; and

FIG. 10 illustrates the placement of a projector according to one embodiment of the invention.

### DETAILED DESCRIPTION OF EMBODIMENTS

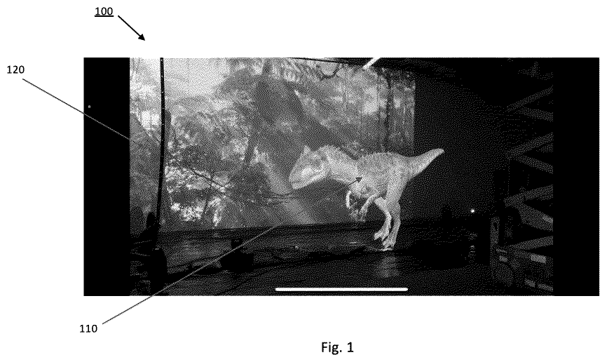

Further features and advantages of the invention, as well as the structure and operation of various embodiments, are described in detail below with reference to the accompanying FIGS. 1-3. Although the invention is described in the context of a theatre, one of ordinary skill in the art readily appreciates that the techniques and embodiments described herein apply to any venue type such as but not limited to an arena, an auditorium, a black box, a proscenium, a ballroom, or a thrust.

The present invention is the result of the combination and specific placement of projection equipment, the combination and specific placement of a plurality of projection surfaces and materials, and the inclusion of a deployable surface system comprising a reflective projection scrim, one or more motors, and trussing permitting, among other things, the retrofit of existing single-screen venues. The projection system delivers a first-ever mixed-media, multi-screen public audience viewing experience, resulting in three-dimensional imagery without headsets.

FIG. 1 illustrates a multi-media, multi-screen projection system 100 according to a core embodiment of the invention. The projection system 100 comprises a holographic scrim 110 and a rear projection screen 120. The holographic scrim 110 is located adjacent to the audience (not shown) and in front or downstage of the rear screen 120. The holographic scrim 110 is a silvered, fire-retardant gauze optimized for transparency, brightness, high contrast, and high-viewing angle. The rear screen 120 is a projector screen, the identification and implementation of which is apparent to one of ordinary skill in the art. A rear projector illuminates the rear screen 120.

In an exemplary embodiment of the invention, the scrim 110 is 62′×38′; however, the size may vary depending on the desired hologram, theater space, and stage size. The scrim 110 is approximately 15′ from the rear screen 120 and hung parallel or nearly parallel with the rear projection system to give the audience the illusion of three-dimensional imagery. This distance, like the size of the scrim, may vary depending on the desired result and the size of the theater space and stage.

Hidden from view are two projectors for projecting the dinosaur image onto the scrim and a third projector for projecting the jungle scenery onto the rear projection screen. These projectors and the cropping and projection techniques they implement are further shown and described in the following embodiment.

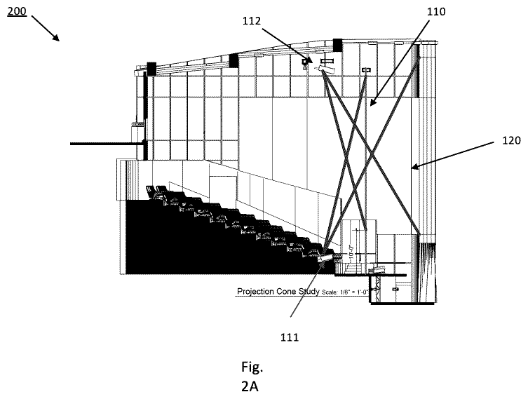

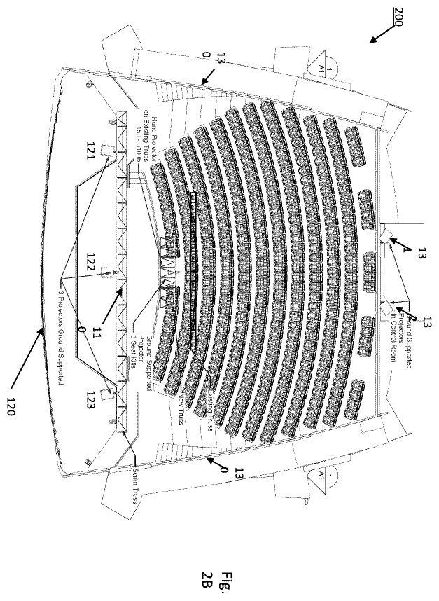

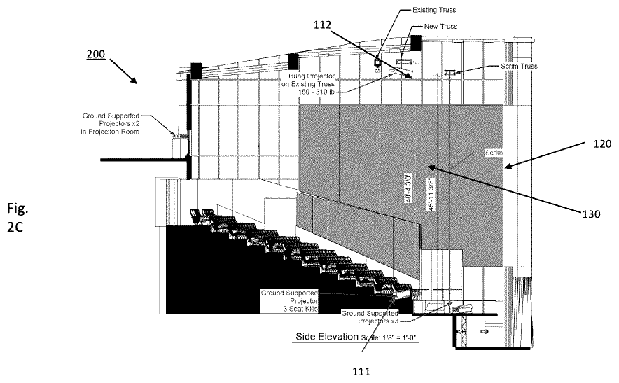

FIG. 2A illustrates a side view of a multi-media, multi-screen projection system 200 in a theatre. Two projectors are utilized for the holographic scrim 110, a first projector 111 on the floor projecting towards the top of the scrim 110 and a second projector 112 on the ceiling projecting towards the bottom of the scrim 110. Each of these projectors 111 and 112, only uses a portion of the projection image. For example, the first projector 111 projects the top half of the projection image, e.g., dinosaur, and the lower half is cropped out, i.e., no image in that portion is projected. Other parts of the projected image may also be cropped, e.g., anything other than the dinosaur's body, as shown in FIG. 1. The second projector 112 projects the lower half portion of the projection image, and the top half portion is cropped out. Projectors 111 and 112 are optimally oriented such that the cumulative projection image is seamlessly shown as a complete projection image, i.e., the top and lower half portions combined without any overlap in the middle.

“Ceiling” and “floor” broadly refer to locations at or near the top and bottom of the scrim 110 and the screen 120. For example, the ceiling refers to the ceiling of the venue, a grid above a stage, a catwalk, or one or more trusses that scrim 110 and/or screen 120 can be hung or suspended from. The floor refers to the stage, a surface in the orchestra or orchestra pit, or any other surface below the ceiling where the projectors can sit.

FIG. 2B illustrates a top view of the multi-media, multi-screen projection system 200. In an exemplary embodiment of the invention, multiple projectors project a projection image onto the rear projection screen 120. For example, three projectors 121, 122, and 123 are ground-supported and project an image on the rear projection screen 120. As shown by the projection cones in FIG. 2A, the rear projection screen 120 is oriented behind the holographic scrim 110 such that the top half portion of the projection image from the first projector 111 and the lower half portion of the projection image from the second projector 112 without impacting the projection image projected onto the rear projection screen 120 by the projectors 121, 122, and 123. Thus, a full-screen holographic image is displayed without affecting the image surface of the projector screen 120.

FIG. 2C illustrates a side view of the multi-media, multi-screen projection system 200 with side wall projection screens according to another embodiment of the invention. Here, a side wall projection screen 130 is placed on or near each side wall of the theater. In an embodiment of the invention, the side wall projection screen 130 comprises one or more muslin panels. Each side wall projection screen 130 is associated with a separate projector. For example, referring to FIG. 2B, a projector 131 at or near a control room projects an image onto the stage right wall screen 130, and a projector 132 at or near a control room projects an image onto the stage left wall screen 130.

In a preferred embodiment, the projection image from the first projector 111 and the second projector 112, the projection image from projectors 121, 122, and 123, the projection image from projector 131, and the projection image from projector 132 are videos with different but complementary content. For example, referring to FIG. 1, the video content displayed on the holographic screen 110 features a dinosaur, and the video content displayed on the rear projector screen 120 features a Jurassic jungle to present the three-dimensional appearance or illusion of a dinosaur moving through her native environment. The video content displayed on the side wall screens 130 complements, for example, the dinosaur and Jurassic jungle, to provide a panoramic viewing experience.

Projectors 111 and 112 utilize ultra-short throw projection lenses with a throw ratio of less than 0.45. The projectors can be placed relatively close to scrim 110 and screen 120 while hidden or not readily apparent to the audience. Projection brightness should be at least 35% brighter than the desired brightness to combat light loss on the scrim 110.

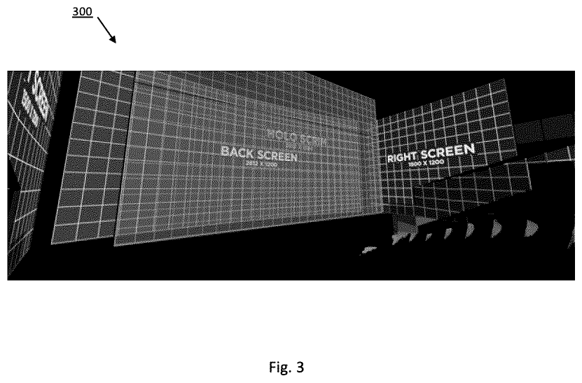

FIG. 3 illustrates the holographic screen 110 (“holo scrim”), the rear projection screen 120 (“back screen”), and the side wall screens 130 (“left screen” and “right screen”) to illustrate the panoramic experience of the audience. The present invention provides a four-screen, multi-layered visual projection experience encompassing 150 degrees and more than 7,000 square feet of projection surface area in this embodiment. The panoramic projection system presents a full-screen holographic image with a desired multi-layer effect. This also creates a multi-layer theatrical viewing experience without needing 3D glasses or wearable aids.

In an embodiment of the invention, the content is formatted for projection mapping, including a three-dimensional scan of the projection surfaces and adjustments to brightness, contrast, saturation, and scale to balance the projected images against each other.

In alternative embodiments of the invention, the scrim projectors 111 and 112 may be placed between the scrim 110 and the rear screen 120, projecting towards the audience. However, the bright light of the projectors 111 and 112 might be visible to audience members and is not ideal. A single projector 111 or 112 may be used in situations where only the top or bottom of the scrim 110 needs imagery, or if the height of the scrim is minimal enough, rear projecting onto the scrim 110.

The HoloTheater enables immersive storytelling to create an emotional connection with the audience. For example, in a presentation about dinosaurs, the latest discoveries in the field of paleontology are shown while bringing the audience closer to dinosaurs than ever before while also placing them in the boots of leading paleontologists, aiming to connect audiences of all ages in that process of discovery. The HoloTheater displays a story brought to the audience in three dimensions using holographic technology, much like an engaging “digital pop-up book.”

Complimentary technologies like artificial intelligence and telepresence, paired with holographic technology, may further enhance the potential impacts of the immersive HoloTheater on education and even the global economy. For example, interactive technologies can be implemented to allow audiences to interact with and learn from past historical figures. The HoloTheater can be used with telepresence technology to make it possible for someone to “beam into” the venue.

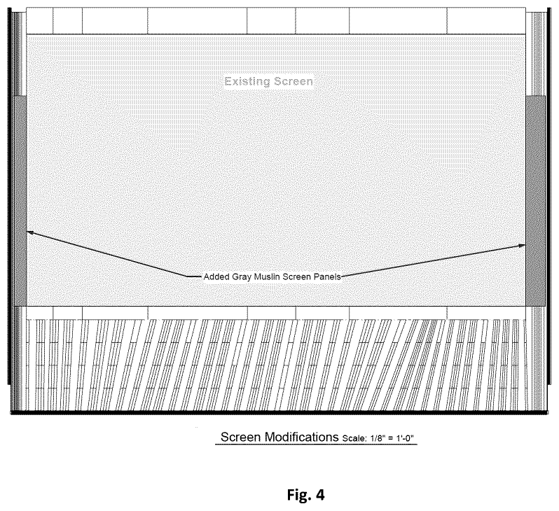

FIG. 4 illustrates a view of an embodiment of the invention as integrated into an existing theater, with side wall screen panels added to the left and right of an existing screen beyond the audience's location. It is shown in this embodiment that the existing screen of the theater does not need to be obscured, adulterated, or removed for deployment of the invention. In an embodiment of the invention, these side wall screen panels may comprise gray muslin. These side wall screen panels may be associated with projectors, and may be used to enhance the three-dimensional, panoramic experience of the audience.

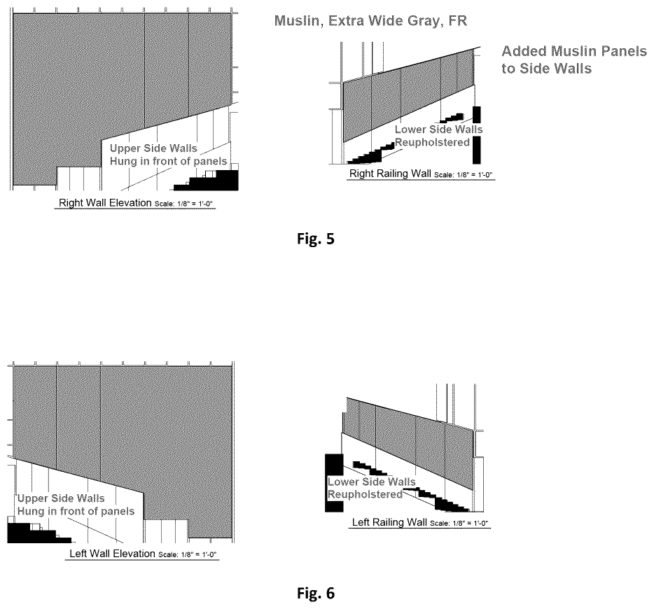

FIG. 5 illustrates a view of the right wall of a theater on which side wall screens have been installed. In an embodiment of the invention, each side of a theater may comprise multiple side wall panels. These panels may comprise extra wide gray muslin. In an embodiment, these panels may be hung in front of existing wall panels. In another embodiment, the side wall screens may take the place of the preexisting side wall material if desired during reupholstering.

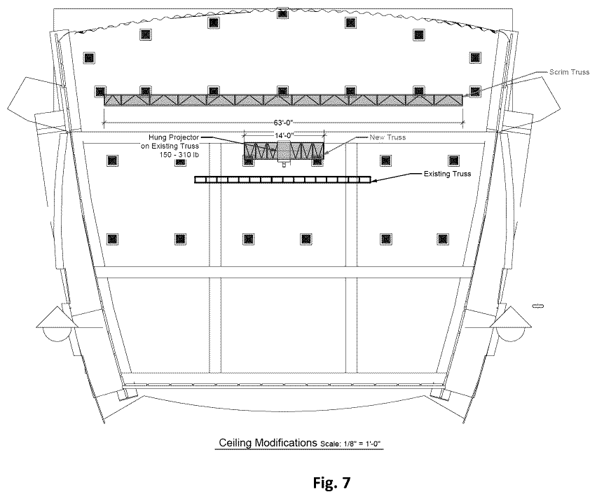

FIG. 6 illustrates a view of the left wall of a theater on which side wall screens have been installed. In an embodiment of the invention, each side of a theater may comprise multiple side wall panels. These panels may comprise extra wide gray muslin. In an embodiment, these panels may be hung in front of existing wall panels. In another embodiment, the side wall screens may take the place of the preexisting side wall material if desired during reupholstering.

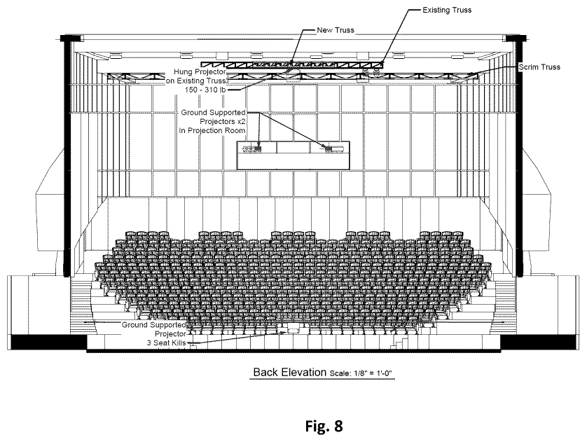

FIG. 7 illustrates a upward view of the roof of a theater, further depicting the installation of the invention. In an embodiment of the invention, a scrim truss may be hung in front of a projector deployed on an existing truss. In an alternative embodiment, the projector may be installed on an existing truss. The scrim truss may be 63 feet wide, and the truss on which the projector is installed may be 14 feet wide. The truss on which the projector is located may be capable of supporting a range of weights including some portion of the range of 150-310 pounds.

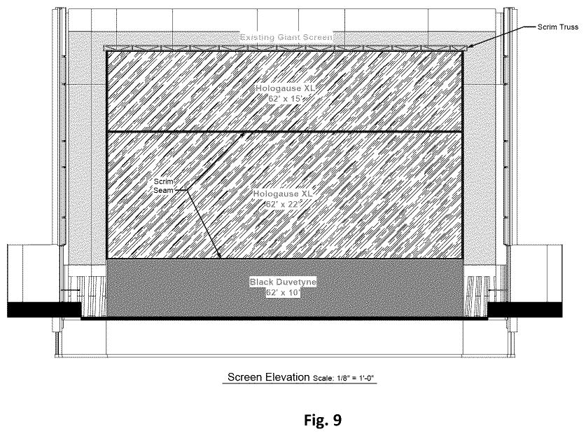

FIG. 8 illustrates a front-facing view from the rear of a theater. In an embodiment of the invention, a projector is deployed an a minimally intrusive location behind the audience. In an embodiment of the invention, one or more additional ground-supported projectors may be located in a specified projection room. One or more additional projectors may further be installed on a new or existing truss on or near the ceiling of the theater. Additionally, in an embodiment of the invention, a specific truss may be deployed to hold the scrim in its vertical and horizontal position.

FIG. 9 illustrates a view of a scrim against an existing screen. In an embodiment of the invention, the existing screen is significantly larger in both the vertical and horizontal dimensions than the scrim is. In an embodiment of the invention, the scrim truss may be located at the level of or below the level of the top of the existing screen, set off by a distance appropriate to the venue. In an embodiment of the invention, the scrim may comprise two sections, or Hologause XL, respectively dimensioned 62 feet wide by 15 feet tall and 62 feet wide by 22 feet tall. In an embodiment of the invention, there may be a black duvetyne attached to the bottom of the scrim. This duvetyne may have the same width as the screen, and be 10 feet in height.

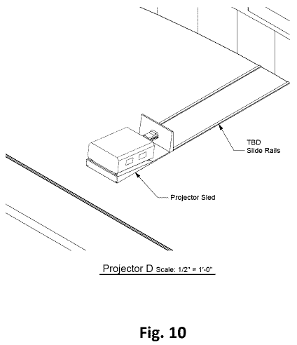

FIG. 10 illustrates the placement of a projector. In an embodiment of the invention, a projector is deployed on a projector sled. This projector sled may be supported by one or more rails. In an embodiment of the invention, the projector sled is supported by two slide rails, one on each side of the sled, holding the projector steady both horizontally and vertically at a distance from a secure element of the theater.

The invention has been described herein using specific embodiments for the purposes of illustration only. It will be readily apparent to one of ordinary skill in the art, however, that the principles of the invention can be embodied in other ways. Therefore, the invention should not be regarded as being limited in scope to the specific embodiments disclosed herein but as fully commensurate in scope with the following claims and their equivalents.

We claim:

1. A projection system comprising:
a scrim suspended vertically between a floor and a ceiling;
a projection screen, wherein the scrim is located between the projection screen and an audience area configured to view the projection system;
a first projector projecting, at an upward angle, a first portion of a first image;
a second projector projecting, at a downward angle, a second portion of the first image, wherein the first image comprises the first portion and the second portion; and
a third projector projecting a first portion of a second image onto the projection screen.

2. The system of claim 1, wherein the scrim and rear projection screen are arranged to form an illusion of a three-dimensional image, as seen in the audience area, comprising the first image and the second image.

3. The system of claim 1, wherein the first projector and second projector are configured as front projectors, and the third projector is configured as a rear projector.

4. The system of claim 1, wherein the scrim comprises a reflective projection scrim or a silvered, fire-retardant gauze.

5. The system of claim 2, wherein the first portion is a top portion cropped from the first image and the second portion is a bottom portion cropped from the first image, and the top portion and the bottom portion do not overlap.

6. The system of claim 5, wherein cropped portions of the first image are not projected.

7. The system of claim 1 further comprising a fourth projector projecting a second portion of the second image onto the projection screen and a fifth projector projecting a third portion of the second image onto the projection screen.

8. The system of claim 1 further comprising one or more side wall screens, wherein each side wall screen is arranged adjacent to either the left or right side of the rear projection screen or the scrim or both the rear projection screen and the scrim.

9. The system of claim 8 further comprising a side wall projector for each side wall screen to project an image complementary to the first image or the second image.

10. A method of presenting three-dimensional mixed media projections comprising the steps of:
dividing a first image into a first portion and a second portion,
projecting the first portion on a top portion of a scrim,
projecting the second portion on a bottom portion of a scrim, and
projecting a second image on a screen, wherein the screen is located upstage of the scrim.

11. The method of claim 10 further comprising the step of suspending the scrim vertically between a ceiling and a stage.

12. The method of claim 11 further comprising the steps of:
arranging a first projector aimed toward the top portion of the scrim, the first projector projecting the first portion on the top of the scrim,
arranging a second projector aimed toward the bottom portion of the scrim, the second projector projecting the second portion on the bottom of the scrim, and
arranging one or more additional projectors aimed toward the rear of the screen, the one or more additional projectors projecting the second image on the screen.

13. The method of claim 12 further comprising the step of aligning the first portion on the top portion of the scrim and the second portion on the bottom portion of the scrim to create a seamless first image and form an illusion of a three-dimensional image comprising the first image and the second image.

14. The method of claim 13 further comprising the step of projecting one or more other images on one or more side wall screens adjacent to either the left or right side of the screen or the scrim or both the screen and the scrim.

15. The method of claim 14 further comprising the step of installing the scrim and the one or more side wall screens into a preexisting theatre comprising the screen.
